(19) United States
(12) Patent Application Publication
(10) Pub. No.: US 2023/0211512 A1
(43) Pub. Date: Jul. 6, 2023

(54) ACTUATOR UNIT AND LINK MECHANISM HAVING SAME

(71) Applicant: OSAKA UNIVERSITY, Osaka (JP)

(72) Inventor: Keisuke KOYAMA, Osaka (JP)

(21) Appl. No.: 17/928,824

(22) PCT Filed: Jun. 4, 2020
(86) PCT No.: PCT/JP2020/022131

§ 371 Date: Nov. 30, 2022

(51) Int. Cl. B25J 15/08; B25J 17/00; B25J 19/06; F16H 1/28; F16H 49/00

(52) U.S. Cl. CPC B25J 15/08; B25J 17/00; B25J 19/06; F16H 1/28; F16H 49/00

(57) ABSTRACT

An actuator unit (1) includes a direct drive motor (2), a first magnetic gear (3) connected to a rotating shaft (6) of the direct drive motor (2), a second magnetic gear (4) configured to be magnetically engaged with the first magnetic gear (3), and a planetary reducer (5) connected to a rotating shaft of the second magnetic gear (4).

### TECHNICAL FIELD

The present invention relates to an actuator unit having backdrivability and a link mechanism including the actuator unit.

### BACKGROUND ART

There has been known a high-speed robot hand provided with a joint that includes: a Harmonic Drive (registered trademark) reducer connected to a rotating shaft of a motor; a first bevel gear connected to an output shaft of the Harmonic Drive (registered trademark) reducer; and a second bevel gear engaged with the first bevel gear (Non-Patent Literature 1).

### CITATION LIST

### Non-Patent Literature

Non-Patent Literature 1
IMAI Yoshio, other four persons, “Shikaku fīdobakku wo mochiita kousoku hando shisutemu no kaihatsu (Development of high-speed hand system using visual feedback)”, the Robotics Society of Japan 20th Anniversary Academic Lecture (Oct. 12-14, 2002), Brochure.

### SUMMARY OF INVENTION

### Technical Problem

However, the high-speed robot hand disclosed in Non-Patent Literature 1 involves (i) a disadvantage of hardly achieving low backlash and low friction due to the bevel gears provided thereto and (ii) a disadvantage of a variation in backlash occurring due to mechanical wear of the gear tooth. Thus, it is difficult to realize a force control and a position control such as a plastically deforming mode, an elastically deforming control mode, and a series elastic actuator mode.

An object of the present invention is to realize (i) an actuator unit that can achieve low backlash and low friction and (ii) a link mechanism including the actuator unit.

### Solution to Problem

In order to attain the above object, an actuator unit in accordance with an aspect of the present invention includes: a motor; a first magnetic gear connected to a rotating shaft of the motor; a second magnetic gear configured to be magnetically engaged with the first magnetic gear; and a planetary reducer connected to a rotating shaft of the second magnetic gear.

In order to attain the above object, a link mechanism in accordance with an aspect of the present invention includes: a first link; a first joint connected to a first end of the first link; a second joint connected to a second end of the first link; and a second link having a first end connected to the second joint, each of the first joint and the second joint including an actuator unit in accordance with an aspect of the present invention.

### Advantageous Effects of Invention

In accordance with an aspect of the present invention, it is possible to realize (i) an actuator unit that can achieve low backlash and low friction and (ii) a link mechanism including the actuator unit.

### BRIEF DESCRIPTION OF DRAWINGS

FIG. 1 is an image illustrating an appearance of a multi-fingered hand in accordance with Embodiment 1.

FIG. 2 is a perspective view illustrating a configuration of an actuator unit included in the multi-fingered hand.

FIG. 3 is a graph illustrating an angle response observed when a PD angle control for a DIP joint in the actuator unit was conducted.

FIG. 4 is a graph illustrating an angular velocity response observed when the PD angle control for the DIP joint was conducted.

FIG. 5 is a graph illustrating an angle response observed when the PD angle control for a PIP joint in the actuator unit was conducted.

FIG. 6 is a graph illustrating an angular velocity response observed when the PD angle control for the PIP joint was conducted.

FIG. 7 is a graph illustrating effects of a friction/cogging torque control for the PIP joint.

FIG. 8 is a view schematically illustrating a mechanism of a Maxwell model control for a first finger included in the multi-fingered hand.

FIG. 9 is a view illustrating, in time series, how the first finger of the multi-fingered hand controlled by the Maxwell model control carries out operation of catching a light-weight object.

FIG. 10 is a view illustrating, in time series, how a first finger of a multi-fingered hand controlled by a control mode in accordance with a comparative example carries out operation of catching a light-weight object.

FIG. 11 is a graph illustrating a relation between virtual spring reaction forces and periods of elapsed time, each of the virtual spring reaction forces acting on the first finger of the multi-fingered hand controlled by the Maxwell model control or the control mode in accordance with the comparative example.

FIG. 12 is a view schematically illustrating a first phase of operation of a multi-fingered hand in accordance with Embodiment 2.

FIG. 13 is a view schematically illustrating a second phase of the operation of the multi-fingered hand.

FIG. 14 is a view schematically illustrating a third phase of the operation of the multi-fingered hand.

FIG. 15 is an image illustrating a motion of the multi-fingered hand that is to grasp a thin plate-like object at a high speed.

FIG. 16 is an image illustrating a motion of the multi-fingered hand that has grasped the thin plate-like object at a high speed.

FIG. 17 is a view schematically illustrating a concept of a plastically deforming control mode of the multi-fingered hand.

FIG. 18 is a view schematically illustrating a concept of a series elastic actuator mode 1 of the multi-fingered hand.

FIG. 19 is an image illustrating a motion of the multi-fingered hand controlled by the first phase for laterally grasping an object on a desk at a high speed.

FIG. 20 is an image illustrating a motion of the multi-fingered hand controlled by the second phase for laterally grasping the object at a high speed.

FIG. 21 is an image illustrating a motion of the multi-fingered hand controlled by the third phase for laterally grasping the object at a high speed.

FIG. 22 is a view schematically illustrating a concept of a series elastic actuator mode 2 of the multi-fingered hand.

FIG. 23 is a view schematically illustrating a concept of an elastically deforming control mode of the multi-fingered hand.

### DESCRIPTION OF EMBODIMENTS

### Embodiment 1

Configuration of Multi-Fingered Hand 15

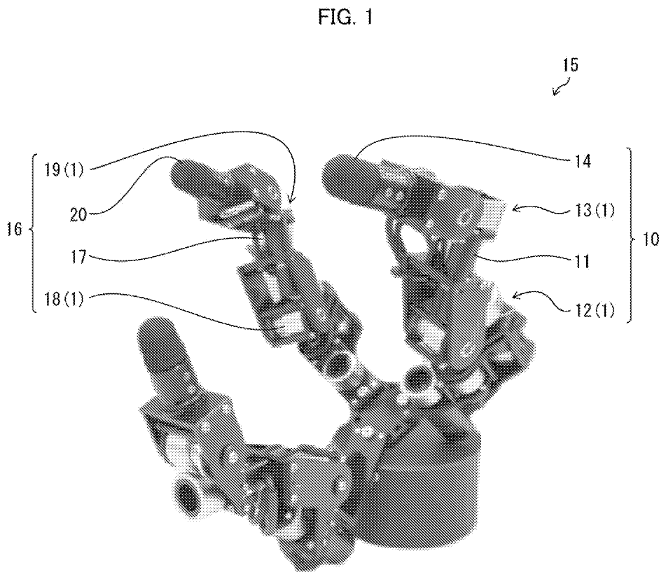

FIG. 1 is an image illustrating an appearance of a multi-fingered hand 15 (link mechanism, robot hand) in accordance with Embodiment 1. The multi-fingered hand 15 includes a first finger 10 (link mechanism, robot hand) and a second finger 16 (link mechanism, robot hand). The first finger 10 includes a first link 11, a PIP joint 12 (first joint) connected to a first end of the first link 11, a DIP joint 13 (second joint) connected to a second end of the first link 11, and a second link 14 connected to a first end of the DIP joint 13. The second finger 16 includes a third link 17, a PIP joint 18 (third joint) connected to a first end of the third link 17, a DIP joint 19 (fourth joint) connected to a second end of the third link 17, and a fourth link 20 connected to a first end of the DIP joint 19. Each of the PIP joints 12 and 18 and the DIP joints 13 and 19 includes an actuator unit 1.

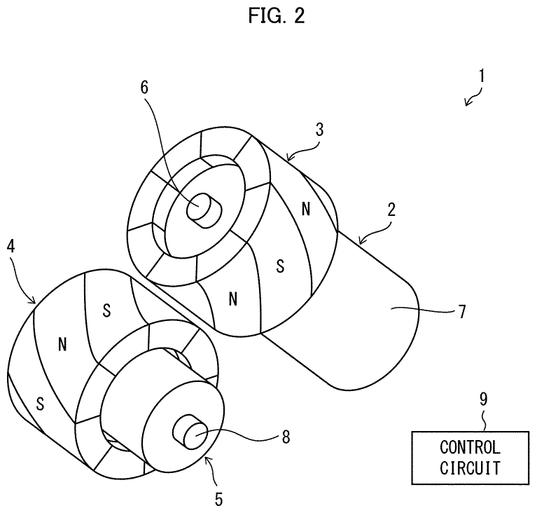

FIG. 2 is a perspective view illustrating a configuration of the actuator unit 1. The actuator unit 1 includes a direct drive motor 2 (motor), a first magnetic gear 3 connected to a rotating shaft 6 of the direct drive motor 2, a second magnetic gear 4 configured to be magnetically engaged with the first magnetic gear 3, and a planetary reducer 5 connected to a rotating shaft of the second magnetic gear 4. Each of the first magnetic gear 3 and the second magnetic gear 4 includes N poles and S poles arranged alternately on an outer peripheral surface of the magnetic gear along a circumferential direction. The first magnetic gear 3 and the second magnetic gear 4 carries out orthogonal conversion of rotation of the direct drive motor 2. Note that the first magnetic gear 3 and the second magnetic gear 4 may be arranged in parallel with each other.

The direct drive motor 2 includes an encoder 7 that measures an amount of reverse rotation of the rotating shaft 6 of the direct drive motor 2, the reverse rotation occurring when an external force torque acts on the output shaft 8 of the planetary reducer 5.

The actuator unit 1 further includes a control circuit 9 that controls, in accordance with the amount of the reverse rotation measured by the encoder 7, the direct drive motor 2 so as to absorb an impact torque acting on the output shaft 8 of the planetary reducer 5.

The control circuit 9 controls the direct drive motor 2 so as to compensate a cogging torque generated at a timing of switching of magnetic poles of the first magnetic gear 3 and the second magnetic gear 4 engaged with each other.

The multi-fingered hand 15 shown in FIG. 1 realizes shock-absorbing catching, and includes eight actuator units 1. As shown in FIG. 2, the actuator unit 1 carries out, by the first and second magnetic gears 3 and 4, orthogonal conversion for the rotating shaft 6 of the small direct drive motor 2, and reduces, by the planetary reducer 5, a rotation speed so as to be within a speed range suitable for application to robots.

The actuator unit 1 constituted by the direct drive motor 2, the planetary reducer 5 having a low reduction ratio, and the first and second magnetic gears 3 and 4 achieves low friction and low backlash, thanks to adoption of the first and second magnetic gears 3 and 4. Thus, the actuator unit 1 has quite excellent backdrivability.

In the actuator unit 1, the direct drive motor 2, the first magnetic gear 3, the second magnetic gear 4, and the planetary reducer 5 are connected in this order. Thus, the planetary reducer 5 amplifies the torques from the first and second magnetic gears 3 and 4. In accordance with the above-described high-speed robot hand disclosed in Non-Patent Literature 1, the reducer disposed so as to precede the magnetic gears carries out torque amplification. Thus, this high-speed robot hand can exert a torque equal to a maximum transmission torque (which is very small) of the magnetic gears. That is, this high-speed robot hand can exert only a small torque. On the other hand, in the actuator unit 1 in accordance with Embodiment 1, torque amplification is carried out by the planetary reducer 5, which is disposed so as to follow the first and second magnetic gears 3 and 4. Thus, the actuator unit 1 can exert a large torque.

Further, a longitudinal direction of the direct drive motor 2 and the output shaft 8 are in such a positional relation that the longitudinal direction of the direct drive motor 2 is orthogonal to the output shaft 8. Thus, it is easy to configure a small robot hand and a small leg robot.

Thanks to adoption of the multi-fingered hand 15 including the actuator units 1 having low friction and low backlash, a shock absorbing control (Maxwell model control) is realized only by a servo control, without using an external sensor. There had never been any examples of a robot hand in which the shock absorbing control was realized only by the servo control. The embodiments of the present invention are the first report of such an example.

In order to improve the backdrivability of the actuator, there have been proposed (i) a method achieved by a combination of torque sensing and a friction compensation control and (ii) a control method involving use of backlash from an output shaft.

However, the above proposals do not consider “arrangement of the actuator and the output shaft”, which is an issue to be considered when a small robot hand or a small leg robot is configured. Meanwhile, in a conventional example, a highly backdrivable hand is configured with use of a hydraulically-driven actuator. However, even now, it is difficult to obtain a small hydraulically-driven actuator with less oil leakage and good response. Currently, some types of series elastic actuators (SEA) having high backdrivability are commercially available. However, these series elastic actuators are large in size, disadvantageously. Further, for the series elastic actuators, it has not been demonstrated whether or not high-responsive force control which absorbs a shock while maintaining contact with a target object and/or an environment when an output shaft of the actuator comes into contact with the target object and/or the environment. Thus, it has been demanded for development of a new actuator which is small, which is operable at a high speed, which has high backdrivability, and with which a compact multi-fingered hand and a compact leg robot can be configured.

Tables 1 and 2 indicate the size and the specifications of a main part of the multi-fingered hand 15 including the actuator units 1 in accordance with Embodiment 1.

TABLE 1

| | |
|---|---|
| Degree of freedom (the number of joints) [−] | 8 |
| Maximum fingertip speed [m/s] | 2.6 |
| Maximum fingertip force [N] | 6.8 |
| Link length (between PIP joint | 77 |
| and DIP joint) [mm] | |
| Link length (between DIP joint | 60.5 |
| and fingertip) [mm] | |
| Finger width [mm] | 35 |

TABLE 2

| | DIP joint | PIP joint |
|---|---|---|
| Reduction ratio [−] | 1/16.4 | 1/16.4 |
| Maximum fingertip speed [rpm] | 182 | 182 |
| Maximum torque [Nm] | 0.41 | 1.0 |
| Backlash [degree] | 0.5 | 0.5 |
| Movable range [degree] | −90 to 90 | −90 to 90 |
| Encoder resolution [p/r] | 500 | 72000 |
| Weight [g] | 110 | 170 |

The second link 14, extending from the fingertip to the distal interphalangeal (DIP) joint 13, had a link length of 60.5 mm. The first link 11, extending from the DIP joint 13 to the proximal interphalangeal (PIP) joint 12, had a link length of 77 mm. The finger width was 35 mm. This multi-fingered hand 15 had a smallest-class size among multi-fingered hands having excellent backdrivability. An actuator, a reducer, and a magnetic gear were selected so that the multi-fingered hand 15 could achieve a speed range and a torque range almost equal to those of high-speed robot hands of rating specifications.

In order to exert a large torque, the PIP joint 12 employed a DD motor (MDS-2018, Microtech Laboratory Inc.) having a diameter of 18 mm and a magnetic gear (FD22S-C-SA, FEC Corporation) of high-torque type. Meanwhile, focusing on achievement of reduction in size and smooth rotation, the DIP joint 13 employed a DD motor (MDS-1318) having a diameter of 13 mm and a magnetic gear (FD22-C-SA) of low cogging type.

The maximum torque of the DIP joint 13 was 0.41 Nm, and the maximum torque of the PIP joint 12 was 1.0 Nm. The maximum rotation speeds of both the joints were 182 rpm. The reduction ratios of both the joints of the multi-fingered hand 15 in accordance with Embodiment 1 were 1/16.4, whereas a reduction ratio of a conventional high-speed hand was 1/50 to 1/100. As compared to the conventional high-speed hand of rating specifications, the maximum torque of the DIP joint 13 was 2.1 times greater, and the maximum torque of the PIP joint 12 was 1.1 times greater. Thus, the multi-fingered hand 15 achieved an increased torque, while achieving a smaller reduction ratio. However, while the first finger 10, which is a one-finger two-joint module, of the conventional high-speed hand, had a weight of 110 g, the first finger 10 of the multi-fingered hand 15 in accordance with Embodiment 1 had a weight of 280 g. Further, the maximum rotation speed of each joint was 0.9 times greater than that of the standard of the conventional high-speed hand of rating specifications. Thus, the conventional high-speed hand is suitable for a high-speed positioning control, and the multi-fingered hand 15 in accordance with Embodiment 1 is suitable for a force control in a high dynamic range.

Table 3 shows a static friction torque, a coulomb friction torque, and a viscous friction torque observed on the side of the rotating shaft 6 of the direct drive motor 2 in each of the DIP joint 13 and the PIP joint 12.

TABLE 3

| | DIP joint | PIP joint |
|---|---|---|
| Static friction [Nm] | 4.0E−3 | 1.68E−2 |
| Viscous friction [Nms/rad] | 3.98E−5 | 3.72E−4 |
| Coulomb friction [Nm] | 3.37E−4 | 1.14E−2 |

The static friction torque is a motor torque command value observed when the rotating shaft 6 starts rotating in response to a torque command given to the direct drive motor 2 in the form of a triangular wave at a sufficiently low rate. Meanwhile, each of the coulomb friction torque and the viscous friction torque is a value estimated by a conventional MD determination method assuming the later-described one-link one-inertia model. The direct drive motor 2 (MDS-1318) of the DIP joint 13 had an instantaneous maximum torque of 0.025 Nm and a static friction force of 4.0E-3 Nm. Thus, a loss caused by the static friction was 16% when determined in relation to the instantaneous maximum torque. Meanwhile, the direct drive motor 2 (MDS-2018) of the PIP joint 12 had an instantaneous maximum torque of 0.13 Nm and a static friction force of 1.68E-2 Nm. Thus, a loss caused by the static friction was 13% when determined in relation to the instantaneous maximum torque. Assuming that the instantaneous motor maximum torques of the DIP joint 13 and PIP joint 12 were 100%, losses caused by the static frictions in both the DIP joint 13 and the PIP joint 12 were not more than 16%. Thus, the multi-fingered hand 15 in accordance with Embodiment 1 had quite low friction, when considering that the multi-fingered hand 15 in accordance with Embodiment 1 was a reducer system including orthogonal conversion.

Angle/Angular Velocity Tracking Characteristics

In order to examine the angle/angular velocity response characteristics of the DIP joint 13 and the PIP joint 12, an experiment on tracking a target angle was conducted in accordance with the following proportional-differential (PD) control formula (1):

τ_{ref-1}=Kₚ₋ᵢ(θ_{ref-i}−θᵢ)−K_{d-i}\dot{θ}ᵢ(i=1,2) (1)

τ_{ref-i} is a torque command value of the joint i, Kₚ₋ᵢ is a proportional gain, and K_{d-i}, is a derivative gain. θ₁ is an angle of the DIP joint 13, and θ₂ is an angle of the PIP joint 12. In accordance with the following formula (2), a target angle value was sequentially given to the shafts of the DIP joint 13 and PIP joint 12, and the target value was swept (changed continuously) for 0 to 2 seconds. Note that, in order to eliminate an effect(s) given by coupled oscillation, the experiment was conducted by fixing the joint(s) not to be driven.

$${θ}_{ref - 1} = \frac{π}{6} sin ( 2 π {t}^{2} ) ( i = 1 , 2 ) \qquad ( 2 )$$

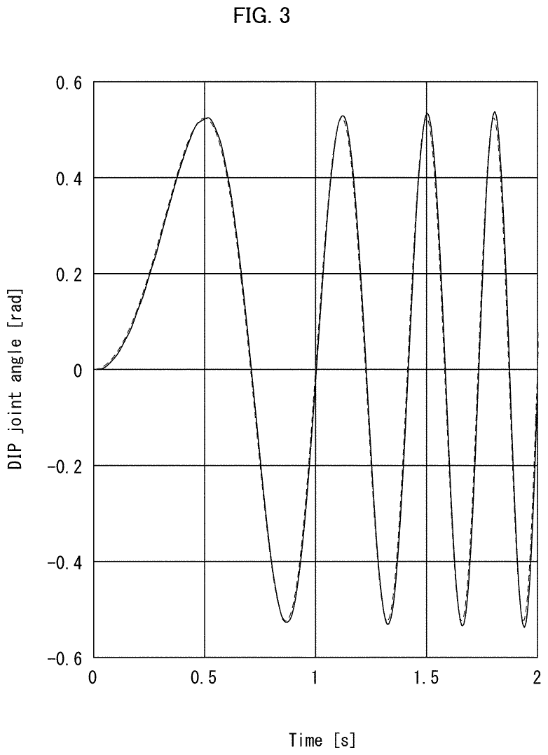

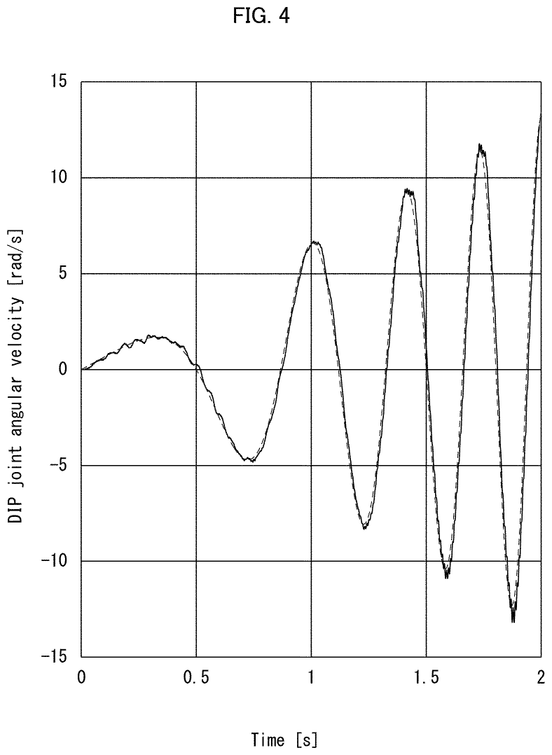

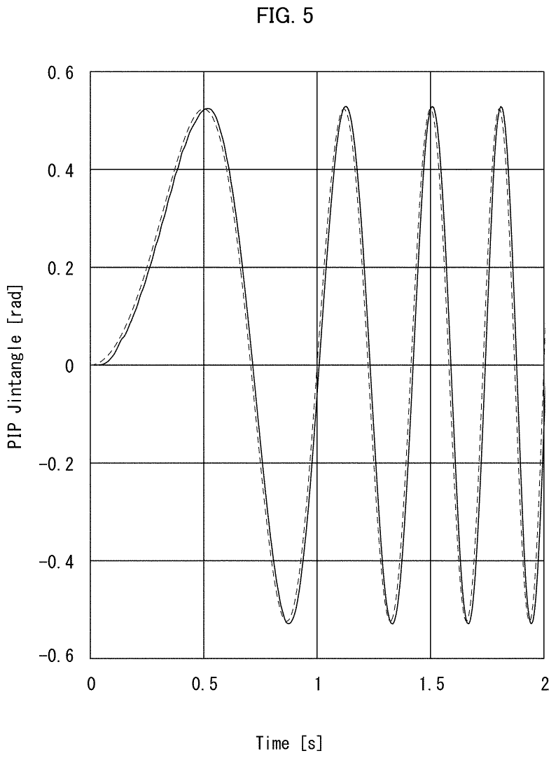

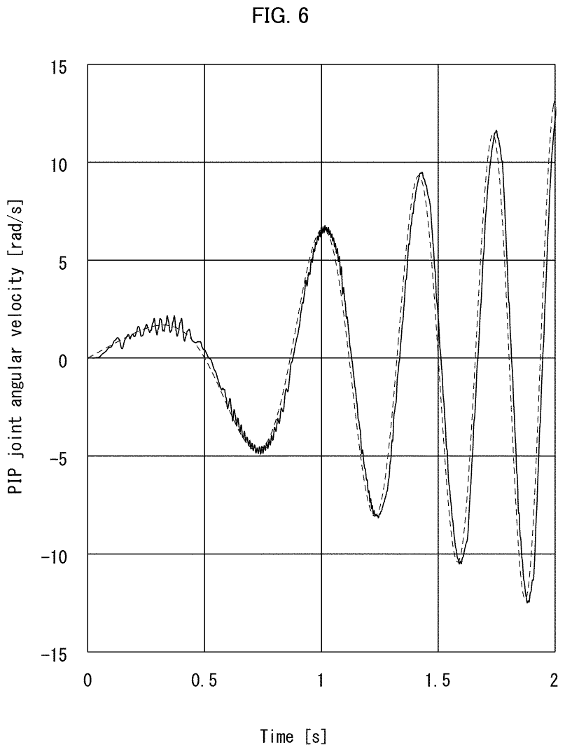

FIG. 3 is a graph illustrating an angle response observed when the PD angle control for the DIP joint 13 was conducted. FIG. 4 is a graph illustrating an angular velocity response observed at that time. FIG. 5 is a graph illustrating an angle response observed when the PD angle control for the PIP joint 12 was conducted. FIG. 6 is a graph illustrating an angular velocity response observed at that time. Note that the angular velocities were calculated by differentiating the angles. The broken line in each graph indicates a target angle value or an ideal velocity value.

FIGS. 3 and 4 show that the DIP joint 13 had good tracking performance with respect to the target values both in the angle and angular velocity. Thanks to adoption of the magnetic gear with low cogging, the DIP joint 13 can carry out smooth angle/velocity control even without friction/cogging compensation.

Meanwhile, FIGS. 5 and 6 show that the PIP joint 12 had pulsations in its angular velocity within an angular velocity range of −5 to 5 rad/s. The reason for this is considered as follows: Focusing on the torque, the PIP joint 12 employed the magnetic gear with a large torque; consequently, a cogging torque generated at a timing of switching of magnetic poles of the magnetic gears reached a level that could not be ignored, which caused pulsations in the velocity.

Friction/Cogging Torque Model and Compensation Control

In order to control the angle and angular velocity of the PIP joint 12, a friction/cogging model is introduced. In order to achieve a simple model, a one-link one-inertia system is employed, and the cogging torque of the magnetic gear is approximated by a cos waveform. The friction/cogging torque model is indicated in the following formula (3):

$$I {\ddot{θ}}_{2 - m} + D {\dot{θ}}_{2 - m} + C sgn ( {\dot{θ}}_{2 - m} ) - {\sum }_{i = 1 , 8} {C}_{i} cos ( {i θ}_{2 - m} + {θ}_{offset - i} ) = {τ}_{ref - 2} = {τ}_{offset - 2} \qquad ( 3 )$$

In the left side of the formula (3), the first item is an inertial force, the second item is a viscous friction force, the third item is a coulomb friction force, and the fourth item is a cogging torque. θ₂₋ₘ is a motor angle of the PIP joint 12, I is a moment of inertia, D is a viscous friction coefficient, C is a coulomb friction coefficient, Cᵢ is a cogging torque coefficient, and θ_{offset-i} is a phase of a cogging waveform. Meanwhile, in the right side of the formula (3), the first item is a torque command, and the second item is a zero-point offset error of the torque command. These parameter values were obtained by the MD determination method and a suitable step response. The friction/cogging compensation is carried out with use of the following parameter determination values in the friction/cogging torque item

[\hat{D}ĈĈ₁Ĉ₈θ_{offset-1}θ_{offset-8}θ_{offset-2}]

and in accordance with the following formula (4):

$${τ}_{ref - 2} = {τ}_{ref - 2}^{′} + D {\dot{θ}}_{2 - m} + C sgn ( {\dot{θ}}_{2 - m} ) - {\sum }_{i = 1.8} {C}_{i} cos ( {i θ}_{2 - m} + {θ}_{offset - i} ) + {τ}_{offset - 2} \qquad ( 4 )$$

In the above formula, τ′_{ref-2} is a torque command value given by the PD control or a torque command value for the shock absorbing control.

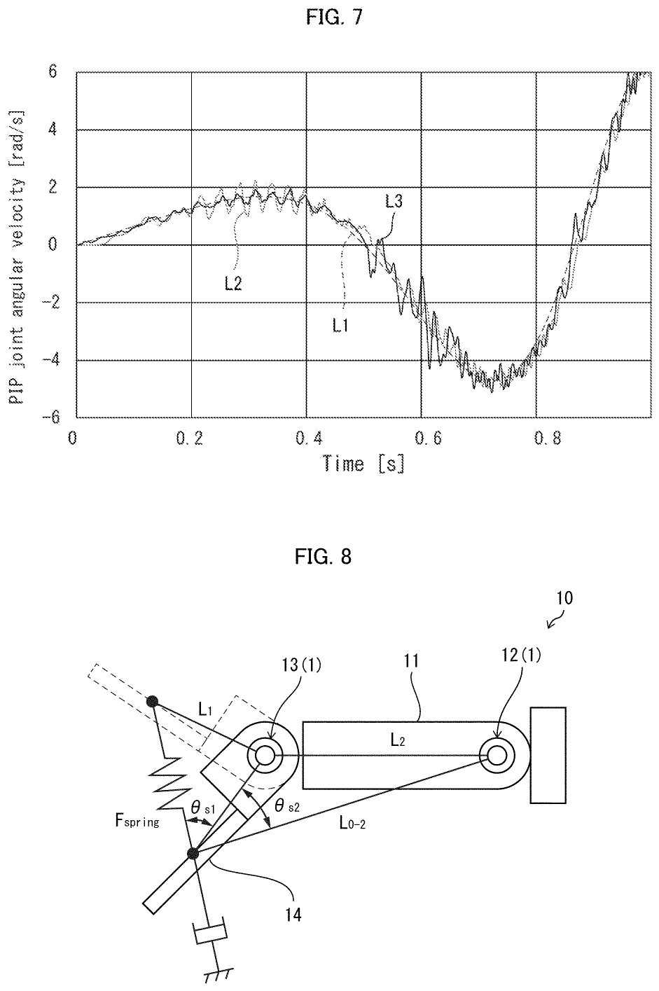

FIG. 7 is a graph showing effects of a friction/cogging torque control for the PIP joint 12. The vertical axis indicates an angular velocity, and the horizontal axis indicates time. The line L1 indicates an ideal value, the line L2 indicates an angular velocity value obtained when the PD control was executed alone, and the line L3 indicates an angular velocity value obtained when the PD control and the friction/cogging torque compensation control were executed in combination. FIG. 7 shows that, in an angular velocity range of 0 to 2 rad/s, the line L3, obtained with use of the friction/cogging torque compensation control, exhibited tracking characteristics improved as compared to the line L2, obtained by the PD control alone. Thus, in the line L3, the pulsations in the angular velocity were clearly reduced. However, in an angular velocity range of −5 to 0 rad/s, the pulsations of the velocity were increased more in the line L3, obtained with use of the friction/cogging torque compensation control. Thus, with this friction/cogging torque model, it is difficult to smoothly control the angle and angular velocity in a task including switching of a joint rotation direction. However, for a task for shock-absorbing catching of an object, for which it is good enough to smoothly control the angle and angular velocity in one direction, the friction/cogging torque model in accordance with Embodiment 1 is used.

Shock-Absorbing Catching

In the multi-fingered hand 15 in accordance with Embodiment 1, the first finger 10 (second finger 16) is configured to have a mechanism with quite low friction. Thus, even when a small external force is applied to the first finger 10, backdriving of the joint occurs. An amount of rotation caused by the backdriving can be accurately measured by the encoder 7 in the direct drive motor 2. This feature is advantageous when estimation of a grasping force or impedance control is carried out with high accuracy without an external sensor. In Embodiment 1, it was demonstrated whether or not the first finger 10 of the multi-fingered hand 15 can realize the series impedance control (Maxwell model control) proposed by the inventors of the present invention.

For a general impedance control, a Voigt model constructed by a spring and a damper connected in parallel is used. With this, however, a reaction force for returning to an initial position would necessarily occur after collision with an object and/or an environment. This reaction force causes a phenomenon that the control target flips back the object in high-speed catching.

In order to deal with this, a control method that employs the Maxwell model constructed by a spring and a damper connected in series is proposed. With the Maxwell model, a plastically deforming behavior (a behavior with which a reaction force for returning to an initial position would not occur) is realized. Thus, the Maxwell model is effective to catching of a light-weight object without flipping it back. The method in accordance with Embodiment 1 causes the DIP joint 13 of the multi-fingered hand 15 to generate a virtual spring force, and then carries out, in accordance with feedback of the spring force, a damping control for the PIP joint 12, thereby realizing the series-connected spring and damper model.

Heretofore, there have been reported some examples that carry out a simulation or measure a variation occurring in an actual spring attached to the hand tip of an actuator so as to catch an object without flipping back the object. However, due to the problem of friction in the mechanism system and the difficulty in maintaining contact with the object, the Maxwell model control carried out only by the servo control has not ever been realized in a robot hand.

Control Formula

In Embodiment 1, the Maxwell model control is realized by making use of the high backdrivability of the actuator unit 1. The conventional methods have employed a position-based control. With the method employing the position-based control, the effects given by friction can be reduced by a position control loop. At the same time, however, this method requires quite high control responsiveness in order to maintain contact between the object and the fingertip, and thus it is difficult to carry out the control in a stable manner.

Meanwhile, Embodiment 1 employs a torque-based control. With this, taking advantage of the high backdriving characteristics of the actuator unit 1, Embodiment 1 can facilitate maintaining of contact between the object and the fingertip.

FIG. 8 is a view schematically illustrating a mechanism of the Maxwell model control for the first finger 10 included in the multi-fingered hand 15.

As shown in FIG. 8, a virtual spring is set at the fingertip of the second link 14 of the first finger 10. Then, on the basis of an initial angle θᵢₙᵢₜᵢₐₗ₋₂ of the DIP joint 13, a virtual spring force F_{spring} is calculated in accordance with the formula (5).

F_{spring}=2KₛK_{g}L₁ cos(θₛ₁) (5)

Kₛ is a spring constant of the virtual spring, K_{g} is a reduction ratio, L1 is a link length between a center of the finger surface and the DIP joint 13, and θₛ₁ is an angle made by an axial direction of the virtual spring and the link L1. With use of the virtual spring force F_{spring}, a torque target value τ_{ref-1} of the DIP joint 13 is given in accordance with the following formula (6).

$${T}_{ref - 1} = \frac{{F}_{spring}}{{K}_{g}} {L}_{1} sin ( {θ}_{s 1} ) \qquad ( 6 )$$

θₛ₂ is an angle made by the link L₁ and the virtual link L₀₋₂ (a distance between the center of the finger surface and the PIP joint 12). Meanwhile, with use of a derivative value of F_{spring}, a damping torque of the PIP joint 12 is given in accordance with the following formula (7).

$${τ}_{ref - 2}^{′} = \frac{{K}_{d}}{{K}_{g}} {\dot{F}}_{spring} {L}_{0 - 2} sin ( {θ}_{s 1} + {θ}_{s 2} ) \qquad ( 7 )$$

K_{d} is a viscosity coefficient of a virtual damper. By the formulae (6) and (7), the virtual spring and the virtual damper connected in series are represented in terms of the coordinates of the hand tip. With this, a plastically deforming behavior in accordance with the Maxwell model is realized.

Experiment

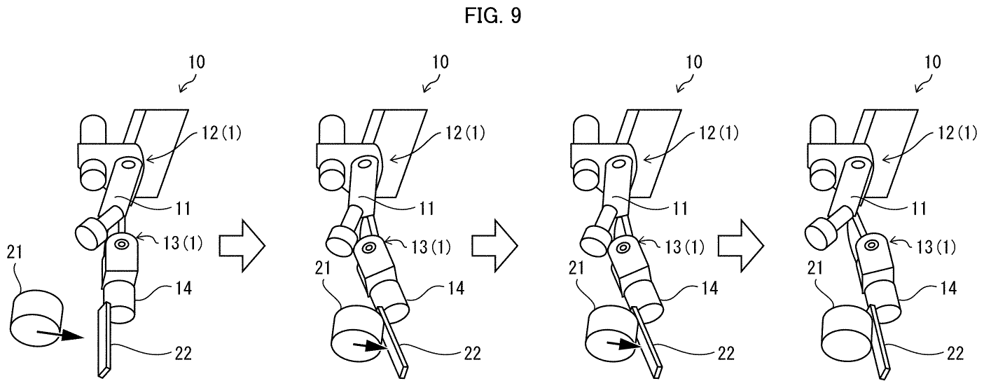

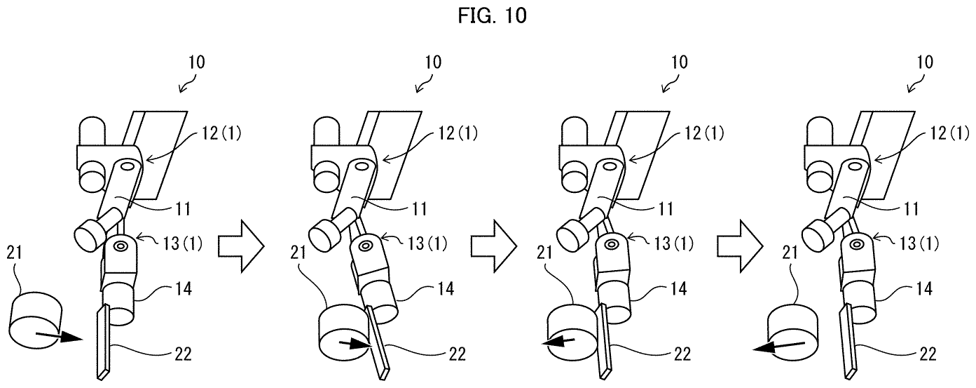

FIG. 9 is a view illustrating, in time series, how the first finger 10 of the multi-fingered hand controlled by the Maxwell model control carries out operation of catching a light-weight object. FIG. 10 is a view illustrating, in time series, how a first finger 10 of a multi-fingered hand controlled by a control mode in accordance with a comparative example carries out operation of catching a light-weight object. Constituent elements identical to those described above are given identical reference signs. The detailed descriptions of such constituent elements will not be given again.

It was demonstrated whether or not the torque-based Maxwell model control enabled catching of a light-weight object 21 without flipping back the light-weight object 21. The object 21 was an iron cylinder having a weight of 100 g. The object 21 was rolled over an inclined surface so as to be accelerated, and was then allowed to collide with a fingertip 22 of the first finger 10, which is a one-finger two-joint module, on a horizontal plane. Note that the fingertip 22 was made of an aluminum flat plate. In order to enhance reproducibility of the experiment, pieces of nonslip tape of approximately 0.2 mm in thickness were bonded to the surface of the fingertip 22, the object 21, and the surface of the experiment device.

As shown in FIG. 9, when the torque-based Maxwell model control was applied to the PIP joint 12 and the DIP joint 13, the fingertip 22 could keep contact with the object 21 without flipping back the object 21.

Meanwhile, FIG. 10 illustrates a state in which a gain for the damping control of the PIP joint 12 was set at zero and catching was carried out only by a behavior of the spring in the DIP joint 13. In this case, the fingertip 22 flipped back the object 21 after coming in contact with the object 21, and thus contact therebetween could not be maintained. Similarly, also in a case where the friction/cogging torque compensation control for the PIP joint 12 was turned off, the fingertip 22 flipped back the object 21 after coming in contact with the object 21, and thus contact therebetween could not be maintained.

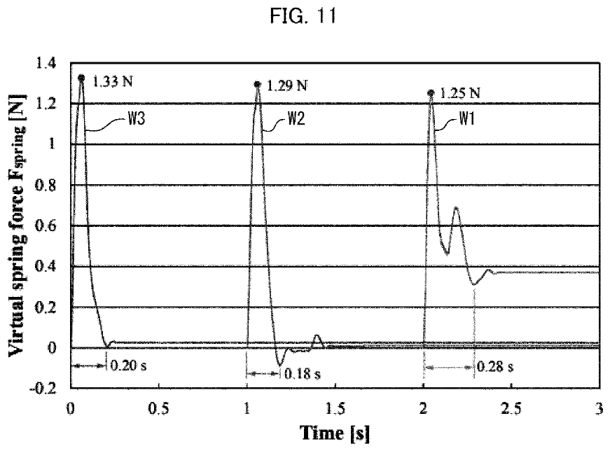

FIG. 11 is a graph illustrating a relation between virtual spring reaction forces and periods of elapsed time, each of the virtual spring reaction forces acting on the first finger 10 of the multi-fingered hand 15 controlled by the Maxwell model control or the control mode in accordance with the comparative example. The waveform W1 indicates a virtual spring reaction force observed when the Maxwell model control with the friction/cogging compensation control was applied, the waveform W2 indicates a virtual spring reaction force observed when the Maxwell model control without the friction/cogging compensation control was applied, and the waveform W3 indicates a virtual spring reaction force observed when the gain for the damping control of the PIP joint 12 was set at zero.

In the waveform W1, a smallest impulsive force and increased contact time were observed. The waveform W1 had two peaks of the virtual spring force. This is a result of a phenomenon, caused by a relatively large gain set for the damping control in the Maxwell model control, that the fingertip 22 was slightly separated from the object 21 after the first collision and thereafter the second collision occurred. In order to maintain the contact continuously, it is necessary to set an appropriate gain for the damping control and to compensate the static friction. The above-indicated results show that combining the first finger 10 of the multi-fingered hand 15 with the torque-based Maxwell control and the friction/cogging torque compensation control makes it possible to reduce the impulsive force at the time of collision with the object 21 so as to increase the contact time. Thanks to these effects, it is possible to catch a light-weight object without flipping it back.

As discussed above, the control circuit 9 carries out the damping control for the actuator unit 1 of the PIP joint 12 so that a force of the virtual damper acts on the second link 14 and carries out the compliance control for the actuator unit 1 of the DIP joint 13 so that a force of the virtual spring acts on the second link 14.

### Effects of Embodiment 1

In accordance with Embodiment 1, it is possible to realize shock-absorbing catching involving use of (i) the new actuator unit 1 having a small size and low friction and (ii) the Maxwell model control. By a combination of the small direct drive motor 2 and the planetary reducer 5, a small reduction ratio and an increased torque can be achieved. By employing the configuration in which orthogonal conversion of the rotating shaft 6 is carried out with use of the first and second magnetic gears 3 and 4, the multi-fingered hand 15 having quite high backdrivability and a small size can be realized. In addition, the first and second magnetic gears 3 and 4 can bring merits of (i) being free from maintenance and (ii) adding a torque limiter function.

In order to deal with the problem that pulsations occur in a low speed range of a rotation speed of the PIP joint 12 due to a cogging torque of the magnetic gear, Embodiment 1 adopts the compensation control according to the friction/cogging torque model that is simple. The compensation control according to the friction/cogging torque model in accordance with Embodiment 1 is effective for a task for which smooth joint driving only in one direction is important, like a task of ball catching.

Thanks to adoption of the actuator unit 1 in accordance with Embodiment 1, the shock-absorbing catching involving use of the Maxwell model control could be realized only by the servo control for the first time. According to the result of the experiment, a period of time in which an impulsive force was generated as a result of collision with the object 21 was 180 to 280 ms, i.e., quite short. In order to reduce the shock in such a short time, it is effective to combine the mechanism according to the actuator unit 1 having high backdrivability with a high-speed torque-based control. Further, by combining a high-speed vision sensor and/or a high-speed, highly accurate proximity sensor with the multi-fingered hand 15, it is possible to aim to (i) realize a higher-speed catching task of a higher level and (ii) advance functions of a product assembling task.

### Embodiment 2

Embodiment 2 proposes grasping operation carried out with use of the multi-fingered hand 15 and the shock absorbing control described in Embodiment 1. This grasping operation which does not use an external sensor brings the first finger 10 (one finger) into contact with a target object to be grasped, and makes the second finger 16 (the other finger) closer to the object, thereby carrying out grasping without stopping the hand tip of the multi-fingered hand 15. Thanks to a combination of the high backdrivability of the multi-fingered hand 15 with the shock absorbing control, it is possible to realize high-speed, seamless operation and to reduce an impact force occurring at grasping. On these points, this operation is effective.

In quasi-static grasping operation, (1) fingertip arrangement along the shape of an object and (2) grasping force adjustment in accordance with a weight of an object and a friction coefficient are emphasized. However, in a case where grasping of a moving object is carried out or grasping is carried out while the robot itself is moving, (3) a method for absorbing an impact force generated at grasping for the purpose of preventing flipping-back of an object and (4) a method for seamlessly executing operation from reaching to grasping for the purpose of accelerating the entire operation are required in addition to (1) and (2) described above. Particularly in assembling of a small part such as a bearing or a plastic product, an object to be grasped is often lighter in weight than the fingertip of the hand. Thus, as the speed of the grasping operation increases, a failure case in which the object is flipped back occurs outstandingly. Further, according to the conventional methods, the reaching operation and the grasping operation are often carried out by different methods. This causes intermissions in the operation of the robot at the timing of switching between these controls, disadvantageously. Embodiment 2 proposes operation of grasping an object in a seamless motion without flipping back the object, the operation being realized by employing the multi-fingered hand 15 and the shock absorbing control (Maxwell model control) in accordance with Embodiment 1.

Grasping Operation

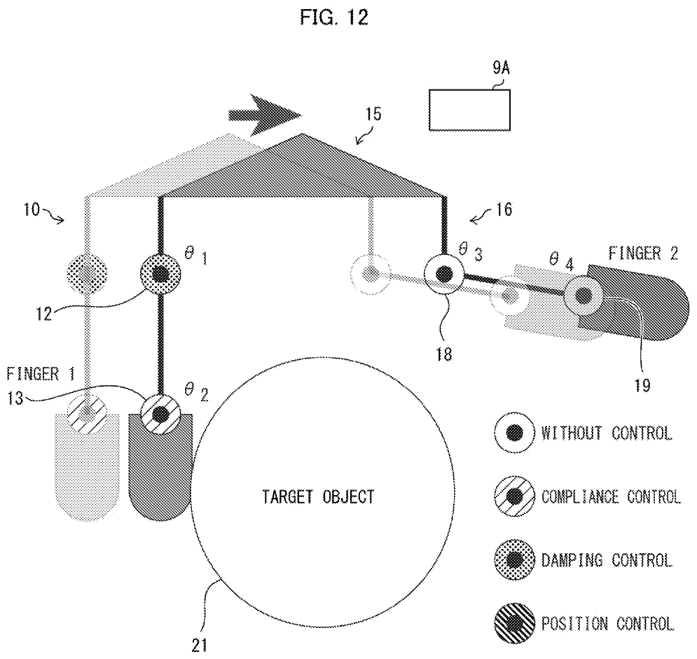

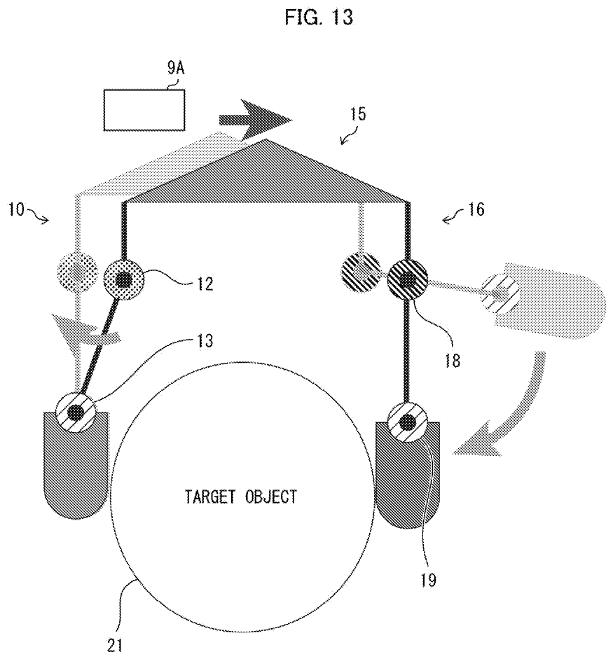

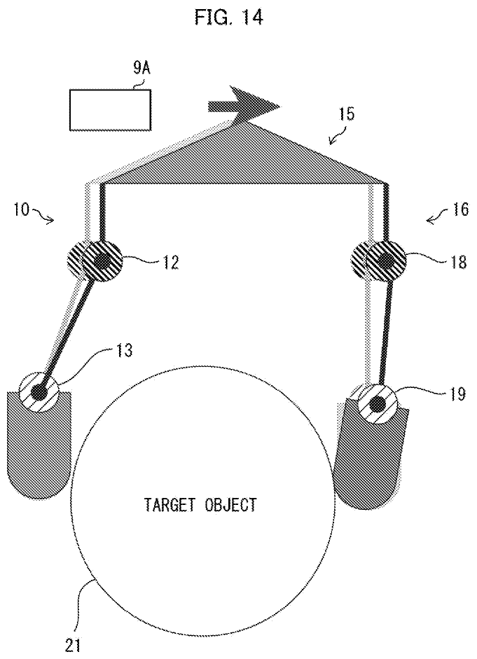

FIG. 12 is a view schematically illustrating a first phase of operation of a multi-fingered hand 15 in accordance with Embodiment 2. FIG. 13 is a view schematically illustrating a second phase of the operation of the multi-fingered hand 15. FIG. 14 is a view schematically illustrating a third phase of the operation of the multi-fingered hand 15. Constituent elements identical to those described above are given identical reference signs. The detailed descriptions of such constituent elements will not be given again.

The following description will discuss how the operation phase is switched from one to another in two fingers and four joints in the multi-fingered hand 15. First, as shown in FIG. 12, the first phase is carried out so as to move the whole of the multi-fingered hand 15 rightward to bring a first finger 10 into contact with an object 21. Then, as shown in FIG. 13, the second phase is carried out to make a second finger 16 approach the object 21 from an opposite side to the first finger 10. In the end, as shown in FIG. 14, the third phase is carried out for grasping force adjustment with use of the first finger 10 and the second finger 16. Note that this operation does not use a tactile sensor or a proximity sensor, but uses only joint angle feedback of the first finger 10 and the second finger 16.

A PIP joint 12 and a DIP joint 13 of the first finger 10 as well as a PIP joint 18 and a DIP joint 19 of the second finger 16 each include an actuator unit 1 described in Embodiment 1. This actuator unit 1 is a small, low-friction actuator constituted by a small direct drive motor 2 (available from Microtech Laboratory Inc.), first and second magnetic gears 3 and 4 of orthogonal conversion type (available from FEC Corporation), and a small planetary reducer 5 (available from Shindensha) (FIG. 2). By employing the small direct drive motor 2 and the small planetary reducer 5 (reduction ratio: approximately 1/16), it is possible to exert a high torque even with a low reduction ratio. Further, by employing a configuration in which orthogonal conversion of a rotating shaft 6 of the direct drive motor 2 is carried out by the first and second magnetic gears 3 and 4, a small, low-friction mechanism is realized. Application of an external force torque to an output shaft 8 causes reverse rotation. An amount of the rotation can be measured by an encoder 7 in the direct drive motor 2. By using the high backdrivability and angle measurement, the actuator unit 1 can realize the compliance control and the damping control only by angle feedback (without use of an external sensor), which is advantageous.

Operation Phases

In all of the first to third phases, the compliance control is carried out for a joint angle θ2 of the DIP joint 13 of the first finger 10 and a joint angle θ4 of the DIP joint 19 of the second finger 16. When a variation in the joint angle θ2 or 04 becomes not less than a threshold, it is determined that a corresponding finger comes into contact with the object 21. Then, the control for the joint angle θ1 or 03 of the PIP joint 12 or 18 of the first finger 10 or the second finger 16 is switched. The PIP joints 12 and 18 are controlled by the damping control or the position control.

In the first and second phases, the damping control is carried out for the PIP joint 12 of the first finger 10, which realizes a plastically deforming behavior together with the compliance control for the DIP joint 13 of the first finger 10. This plastically deforming behavior can reduce an average impulsive force generated when the object 21 and the first finger 10 collide with each other, whereby the first finger 10 can maintain contact with the object 21 without flipping it back. Then, at the time when the variation in the angle of the joint angle θ2 of the DIP joint 13 of the first finger 10 exceeds a threshold, the first phase is switched to the second phase.

In the second phase, the position control is carried out for the joint angle θ3 of the PIP joint 18 of the second finger 16 so as to make the second finger 16 approach the object 21. Then, at a time when a variation in the joint angle θ4 of the DIP joint 19 of the second finger 16 becomes not less than a threshold, the operation phase is switched to the third phase.

In the third phase, the position control is carried out both for the joint angle θ1 of the PIP joint 12 of the first finger 10 and the joint angle θ3 of the PIP joint 18 of the second finger 16. The grasping force adjustment is carried out such that (i) the joint angle θ1 of the first finger 10 is maintained at an angle set at the time when the third phase is started and (ii) the joint angle θ3 of the second finger 16 is set so that a variation occurring in a virtual spring as a result of the compliance control for the DIP joint 19 becomes constant.

In the method in accordance with Embodiment 2, the DIP joints 13 and 19 are always under the compliance control. This provides an advantage of facilitating maintaining of contact between the object 21 and the fingertip. Further, the feedback loop is closed only in the control of the multi-fingered hand 15. Therefore, in the robot arm including the multi-fingered hand 15, only the Point to Point (P to P) position control may be carried out. When the position of the hand tip of the robot arm is caused to move toward an object 21, which is a target object to be grasped, the multi-fingered hand 15 automatically detects contact with the object 21 and grasps the object 21 while carrying out the shock absorbing control. This is a feature of the method in accordance with Embodiment 2.

As discussed above, a control circuit 9A executes, in order to grasp an object 21 with a small shock, (i) the first phase that carries out the damping control for the PIP joint 12 and carries out the compliance control for the DIP joint 13, (ii) the second phase that carries out the position control for the PIP joint 18 and causes the DIP joint 19 to get closer to the object 21, and (iii) the third phase that carries out the position control for the PIP joint 12 and carries out the position control for the PIP joint 18 so that a variation occurring in a virtual spring as a result of the compliance control for the DIP joint 19 becomes constant, the first phase, the second phase, and the third phase being executed in this order.

Grasping Experiment A multi-fingered hand 15 including two fingers and four joints was configured with use of four actuator units 1. The multi-fingered hand 15 was attached to an arm (UR5e) available from Universal Robot Co., Ltd. A motor driver of each actuator unit 1 was connected to a real-time controller (dSPACE). Then, angle feedback of the encoder 7 was carried out per ms, and a torque control (current control) for the actuator unit 1 was carried out. Note that, on the real-time controller, a torque command value-type PD position control or a shock absorbing control was carried out with use of an angle from the encoder 7. A controller of the arm was connected to the real-time controller merely via an input-output (TO) port. From the real-time controller, only a signal regarding a timing to start arm operation was supplied to the controller of the arm. Upon reception of this signal, the controller of the arm started a feed forward control for the position of the hand tip of the arm. Note that a target value of the position of the hand tip of the arm was set so as to allow the arm to pass through each of the positions away from the position of the object 21 by ±30 mm, for the purpose of dealing with an error in positioning of the object 21.

The multi-fingered hand 15 could grasp a plastic bottle, a can, and a portable handset of a telephone. After the first finger 10 collided with the object 21, the second finger 16 got closer to the object 21. Then, the first finger 10 and the second finger 16 held two sides of the object 21, and lifted up the object 21. Although the plastic bottle, the can, and the portable handset of the telephone were different in weight and size, the plastic bottle, the can, and the portable handset of the telephone could be grasped with the same parameter. The method in accordance with Embodiment 2 has robustness against an error in positioning of the object 21 in a direction approaching the hand tip of the arm and an error in width of the object 21, and thus enables grasping of the object 21 with a seamless motion while reducing an impact force from the object 21.

Small-Shock, Nonstop Grasping (Vertical Motion of Arm)

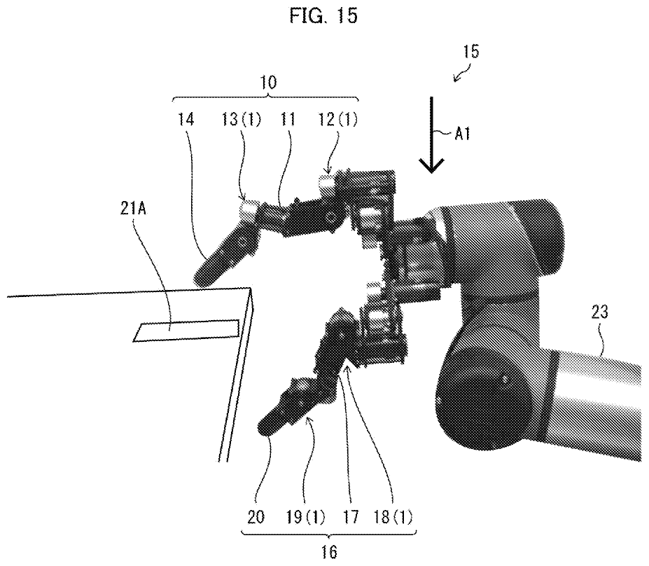

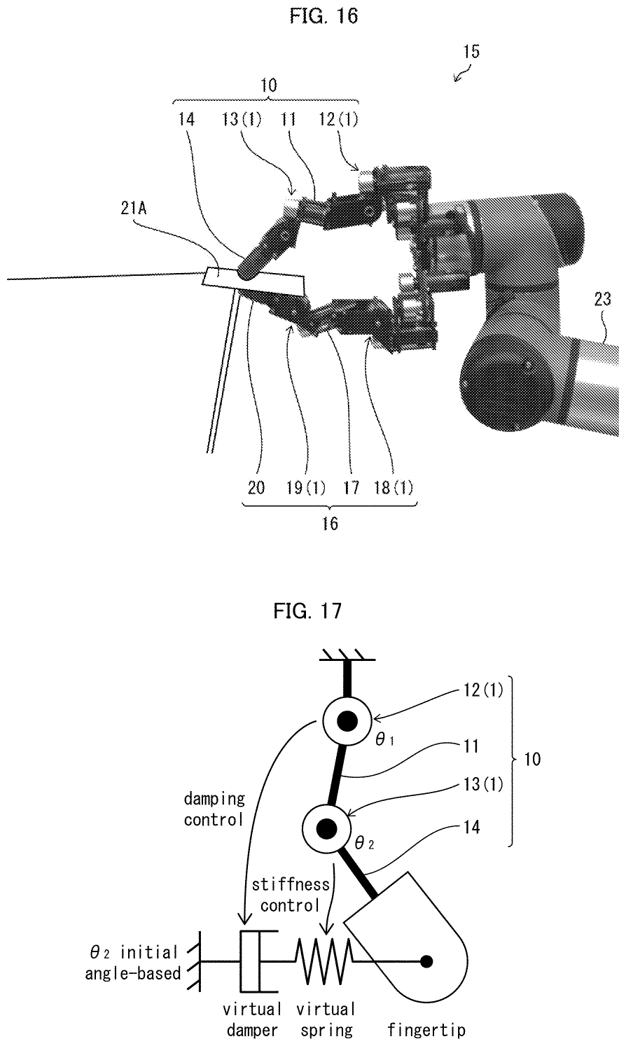

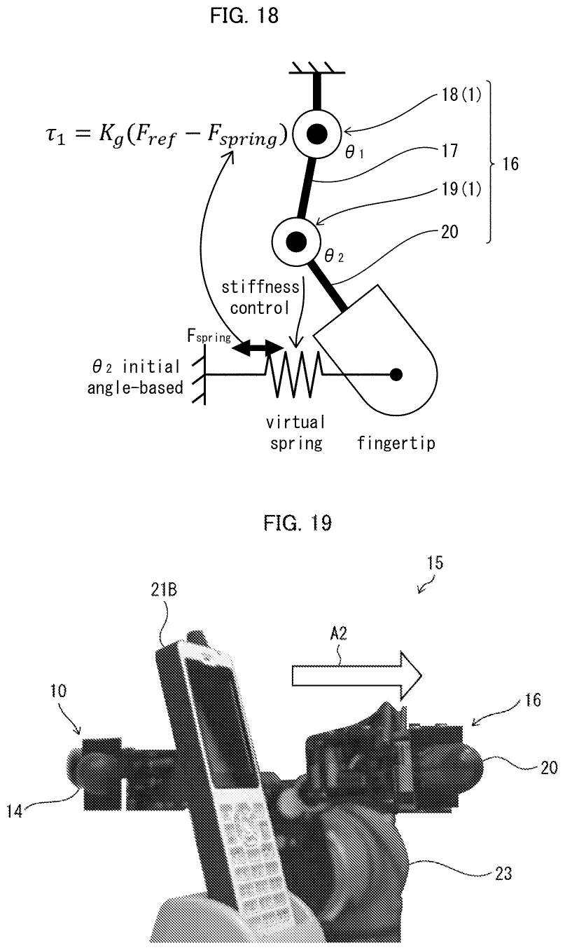

FIG. 15 is an image illustrating a motion of a multi-fingered hand 15 that is to grasp a thin plate-like object 21A at a high speed. FIG. 16 is an image illustrating a motion of the multi-fingered hand 15 that has grasped the object 21A at a high speed. FIG. 17 is a view schematically illustrating a concept of a plastically deforming control mode of the multi-fingered hand 15. FIG. 18 is a view schematically illustrating a concept of a series elastic actuator mode 1 of the multi-fingered hand 15. Constituent elements identical to those described above are given identical reference signs. The detailed descriptions of such constituent elements will not be given again.

The multi-fingered hand 15 attached to an arm 23 included a first finger 10 and a second finger 16. First, the arm 23 was caused to approach the thin plate-like object 21A on a desk from an upper side as indicated by the arrow A1, thereby bringing the tip of a second link 14 of the first finger 10 into contact with the object 21A. The object 21A was a business card.

The first finger 10 was caused to operate in the plastically deforming mode shown in FIG. 17. This plastically deforming mode corresponds to the plastically deforming mode described in Embodiment 1. An actuator unit 1 of the DIP joint 13 was controlled so that a virtual spring force acted on the tip of the second link 14. An actuator unit 1 in the PIP joint 12 was controlled so that a virtual damper force acted on the tip of the second link. Consequently, an impact force from the object 21A was absorbed.

Next, the second finger 16 was caused to operate in the series elastic actuator mode 1 shown in FIG. 18. An actuator unit 1 of the DIP joint 19 was controlled so that a virtual spring force acted on the tip of a fourth link 20. An actuator unit 1 of the PIP joint 18 carried out a grasping force control so that a variation occurring in the virtual spring force as a result of control of the DIP joint 19 became constant, thereby maintaining a constant contact force with respect to the object 21A.

The multi-fingered hand 15 could grasp the object 21A, which was the business card on the desk, with a small shock and nonstop at a high speed. A period of time taken from the approaching to the grasping was not more than 1 second.

Small-Shock, Nonstop Grasping (Lateral Motion of Arm)

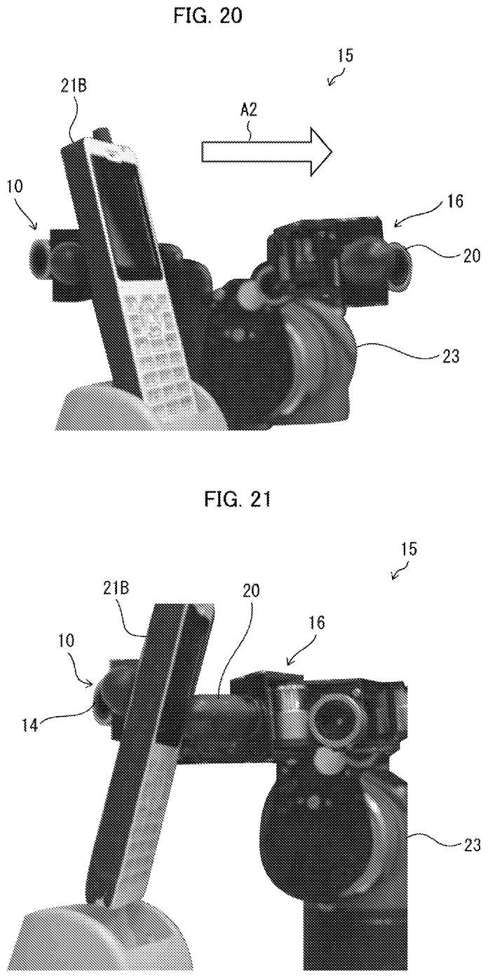

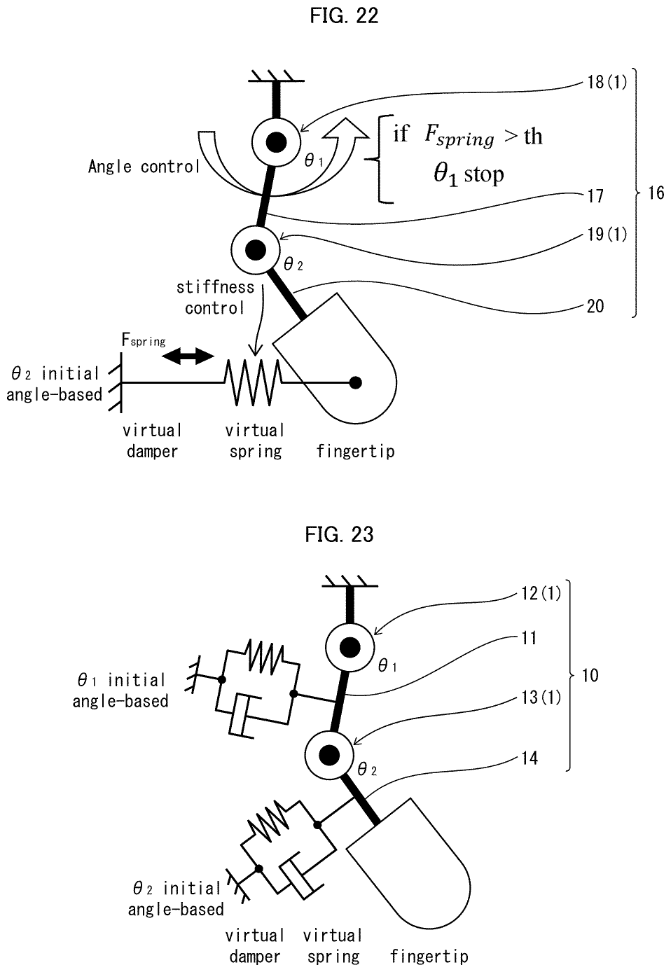

FIG. 19 is an image illustrating a motion of the multi-fingered hand 15 controlled by the first phase for laterally grasping an object 21B on a desk at a high speed. FIG. 20 is an image illustrating a motion of the multi-fingered hand 15 controlled by the second phase for laterally grasping the object 21B at a high speed. FIG. 21 is an image illustrating a motion of the multi-fingered hand 15 controlled by the third phase for laterally grasping the object 21B at a high speed. FIG. 22 is a view schematically illustrating a concept of a series elastic actuator mode 2 of the multi-fingered hand 15. FIG. 23 is a view schematically illustrating a concept of an elastically deforming control mode of the multi-fingered hand 15. Constituent elements identical to those described above are given identical reference signs. The detailed descriptions of such constituent elements will not be given again.

The multi-fingered hand 15 attached to an arm 23 includes a first finger 10 and a second finger 16. First, the arm 23 was caused to laterally approach the object 21B on the desk as indicated by the arrow A2, thereby bringing the tip of the second link 14 of the first finger 10 into contact with the object 21B. The object 21B was a portable handset of a telephone. The first finger 10 was caused to operate in the above-described plastically deforming mode. With this, an impact force from the object 21A was absorbed.

Next, the second finger 16 was caused to operate in the series elastic actuator mode 2 shown in FIG. 22. An actuator unit 1 of the DIP joint 19 was controlled so that a virtual spring force acted on the tip of a fourth link 20. An actuator unit 1 of the PIP joint 18 was controlled for an angular position. With this, the fingertip of the fourth link 20 of the second finger 16 approached the object 21B until the fingertip of the fourth link 20 of the second finger 16 came into contact with the object 21B.

Thereafter, the first finger 10 and the second finger 16 were caused to operate in the elastically deforming control mode shown in FIG. 23. The actuator units 1 of the DIP joints 13 and 19 and PIP joints 12 and 18 were controlled by the Voigt model constructed by a virtual spring and a virtual damper connected in parallel. With this, a constant contact force was maintained between (i) the first finger 10 and second finger 16 and (ii) the object 21B.

The multi-fingered hand 15 could grasp the object 21B, which was the portable handset on the desk, with a small shock and nonstop at a high speed. A period of time taken from the approaching to the grasping was not more than 1 second.

As discussed above, in order to grasp the object 21B with a small shock, the control circuit 9A carries out the damping control for the PIP joint 12 and the compliance control for the DIP joint 13 as well as the angle control for the PIP joint 18 and the compliance control for the DIP joint 19, and then controls the PIP joint 12, DIP joint 13, PIP joint 18, and DIP joint 19 by the model constructed by the virtual spring and the virtual damper connected in parallel.

### Effects of Embodiment 2

In accordance with Embodiment 2, it is possible to realize the dynamic grasping operation involving use of the actuator unit 1 having high backdrivability and the shock absorbing control. This grasping operation carries out detection of contact with an object and the shock absorbing control only by joint angle feedback, so as to carry out grasping while continuously moving the position of the hand tip of the arm. The DIP joints 13 and 19 are always under the compliance control, which provides an advantage of facilitating maintaining of contact with the object 21A or 21B. Although this operation includes switching of the operation phase for the PIP joints 12 and 18 of the first finger 10 and the second finger 16, this operation operates seamlessly between a non-contact state and a contact state. Thus, this operation is suitable for high-speed grasping while moving. Further, since the feedback loop is closed on the multi-fingered hand 15 side, the control of the multi-fingered hand 15 and the control of the arm 23 can be carried out asynchronously, which is advantageous. Thanks to this advantage, the multi-fingered hand 15 can be attached to other arms than the arm (UR5e) manufactured by Universal Robot Co., Ltd. If the position of the hand tip of an arm having the multi-fingered hand 15 attached thereto is caused to approach an object 21A or 21B, then the multi-fingered hand 15 automatically carries out grasping operation in accordance with the position and the width size of the object 21A or 21B. Thus, the grasping operation having robustness can be achieved with a quite simple control system.

As indicated below (Table 4), as compared to the conventional direct drive motor, series elastic actuator (SEA), soft robot, and hydraulic configuration, the actuator unit 1 in accordance with Embodiment 1 or 2 has a relatively small size and a small hysteresis of force/variation and are excellent in variable impedance, service life/durability, and availability of an element part(s).

TABLE 4

| | | Series | | | |
|---|---|---|---|---|---|
| | | elastic | | | |
| | | actuator | Soft | | Actuator |
| | DD motor | (SEA) | robot | Hydraulic | unit 1 |
| Size | Large- | Relatively | Small | Large | Relatively |
| | torque | large | size | size | small size |
| | product -> | size | | | (orthogonal |
| | Large size | (thick) | | | output) |
| Weight | Relatively | Relatively | Light | Heavy | Relatively |
| | heavy | light | | | heavy |
| Hysteresis of | Small | Medium | Large | Small | Small |
| force/variation | | | | | |
| Variable | Good | Poor | Poor | Good | Good |
| impedance | | | | | |
| Service | Good | Poor | Poor | Good | Good |
| life/durability | | | | | |
| Availability of | Good | Good | Good | Poor | Good |
| element part(s) | | | | | |

Usage

The multi-fingered hands 15 each including the actuator unit 1 in accordance with Embodiment 1 or 2 are applicable not only to robot hands and multi-leg robots but also to other various purposes.

For example, the actuator unit 1 may be applied to a rehabilitation tool used for rehabilitation in a case where a person gets paralysis of his/her hand. With the rehabilitation tool, actual springs are connected to the fingers of a wearer, and the springs pull the fingers in a direction of opening the hand. The wearer repeatedly carries out operation of making a first and opening the hand, as a training for recovery from the paralysis of the hand. By applying the actuator unit 1 to such a rehabilitation tool, the lengths and strengths of the springs can be changed by control.

Alternatively, the shock absorbing control of the actuator unit 1 may be applied to a door opening/closing device. This can enhance safety against an impact force acting on a door.

Further alternatively, the shock absorbing control of the actuator unit 1 may be applied to a drawer in a kitchen or the like in which a dangerous good(s) such as a knife can be housed. This can enhance safety against an impact force acting on the drawer.

Aspects of the present invention can also be expressed as follows:

An actuator unit 1 in accordance with aspect 1 of the present invention includes: a motor (direct drive motor 2); a first magnetic gear 3 connected to a rotating shaft 6 of the motor (direct drive motor); a second magnetic gear 4 configured to be magnetically engaged with the first magnetic gear 3; and a planetary reducer 5 connected to a rotating shaft of the second magnetic gear 4.

With this feature, a torque generated by the motor is transmitted via the first magnetic gear and second magnetic gear with low backlash and low friction loss. Then, this torque is amplified by the planetary reducer. That is, thanks to this feature, it is possible to achieve an actuator unit with low backlash, low friction, and large torque.

An actuator unit 1 in accordance with aspect 2 of the present invention is preferably configured such that, in the aspect 1, the motor (direct drive motor 2) includes an encoder 7 configured to measure an amount of reverse rotation of the rotating shaft 6 of the motor (direct drive motor 2), the reverse rotation occurring when an external force torque acts on an output shaft 8 of the planetary reducer 5.

With the above configuration, it is possible to detect the external force torque acting on the output shaft of the planetary reducer.

An actuator unit 1 in accordance with aspect 3 of the present invention is preferably configured such that, in the aspect 2, the actuator unit 1 further includes a control circuit 9, 9A configured to control, in accordance with the amount of the reverse rotation measured by the encoder 7, the motor (direct drive motor 2) so as to absorb an impact torque acting on the output shaft 8 of the planetary reducer 5.

With the above configuration, it is possible to realize the shock absorbing control (Maxwell model control) only by servo control without using an external sensor.

An actuator unit 1 in accordance with aspect 4 of the present invention is preferably configured such that, in the aspect 3, the control circuit 9, 9A controls the motor (direct drive motor 2) to compensate a cogging torque generated at a timing of switching of magnetic poles of the first magnetic gear 3 and the second magnetic gear 4 engaged with each other.

With the above configuration, magnetic gears with a large torque can be employed as the first and second magnetic gears.

An actuator unit 1 in accordance with aspect 5 of the present invention is preferably configured such that, in the aspect 1, the first magnetic gear 3 and the second magnetic gear 4 carry out orthogonal conversion of rotation of the motor (direct drive motor 2).

With the above configuration, the actuator unit can be configured in a compact size.

A link mechanism (multi-fingered hand 15, first finger 10, and second finger 16) in accordance with aspect 6 of the present invention includes: a first link 11; a first joint (PIP joint 12) connected to a first end of the first link 11; a second joint (DIP joint 13) connected to a second end of the first link 11; and a second link 14 having a first end connected to the second joint (DIP joint 13), each of the first joint (PIP joint 12) and the second joint (DIP joint 13) including the actuator unit 1 in accordance with aspect 1 of the present invention.

With this feature, it is possible to reduce the frictions of the first joint and the second joint to a quite low level.

A link mechanism (multi-fingered hand 15, first finger 10, second finger 16) in accordance with aspect 7 of the present invention is preferably configured such that, in the aspect 6, the link mechanism further includes a control circuit 9, 9A configured to control the motor (direct drive motor 2) to compensate a cogging torque generated at a time of switching of magnetic poles of the first magnetic gear 3 and the second magnetic gear 4 of the first joint (PIP joint 12) engaged with each other.

With the above configuration, it is possible to reduce a cogging torque generated at a timing of switching of the magnetic poles of the first and second magnetic gears in the actuator unit of the first joint that employs magnetic gears with a large torque focusing on a torque.

A link mechanism (multi-fingered hand 15, first finger 10, second finger 16) in accordance with aspect 8 of the present invention is preferably configured such that, in the aspect 6, the link mechanism further includes a control circuit 9, 9A configured to carry out (i) a damping control for the actuator unit 1 of the first joint (PIP joint 12) so that a force of a virtual damper acts on a second end of the second link 14 and (ii) a compliance control for the actuator unit 1 of the second joint (DIP joint 13) so that a force of a virtual spring acts on the second end of the second link 14.

With the above configuration, the link mechanism can catch an object while absorbing a shock.

A link mechanism (multi-fingered hand 15) in accordance with aspect 9 of the present invention is preferably configured such that, in the aspect 6, the link mechanism further includes: a third link 17; a third joint (PIP joint 18) connected to a first end of the third link 17; a fourth joint (DIP joint 19) connected to a second end of the third link 17; and a fourth link 20 having a first end connected to the fourth joint (DIP joint 19), each of the third joint (PIP joint 18) and the fourth joint (DIP joint 19) including the actuator unit 1 in accordance with aspect 1 of the present invention.

With the above configuration, it is possible to reduce the frictions of the third joint and the fourth joint to a quite low level.

A link mechanism (multi-fingered hand 15) in accordance with aspect 10 of the present invention is preferably configured such that, in the aspect 9, the link mechanism further includes a control circuit 9, 9A configured to execute, in order to grasp a target object (object 21, 21A) with a small shock, (i) a first phase that carries out a damping control for the first joint (PIP joint 12) and carries out a compliance control for the second joint (DIP joint 13), (ii) a second phase that carries out a position control for the third joint (PIP joint 18) and causes the fourth joint (DIP joint 19) to get closer to the target object (object 21, 21A), and (iii) a third phase that carries out a position control for the first joint (PIP joint 12) and carries out a position control for the third joint (PIP joint 18) so that a variation occurring in a virtual spring as a result of a compliance control for the fourth joint (DIP joint 19) becomes constant, the first phase, the second phase, and the third phase being executed in this order.

With the above configuration, thanks to a combination of high backdrivability of the multi-fingered hand and the shock absorbing control, it is possible to realize high-speed, seamless grasping operation and to reduce an impact force occurring in the grasping operation.

A link mechanism (multi-fingered hand 15) in accordance with aspect 11 of the present invention is preferably configured such that, in the aspect 9, the link mechanism further includes a control circuit 9A configured to carry out, in order to grasp a target object (object 21B) with a small shock, a damping control for the first joint (PIP joint 12) and a compliance control for the second joint (DIP joint 13) as well as an angle control for the third joint (PIP joint 18) and a compliance control for the fourth joint (DIP joint 19) and then to control the first to fourth joints (PIP joint 12, DIP joint 13, PIP joint 18, DIP joint 19) by a model constructed by a virtual spring and a virtual damper connected in parallel.

With the above configuration, it is possible to grasp an object on a desk with a small shock and nonstop at a high speed.

A link mechanism (multi-fingered hand 15) in accordance with aspect 12 of the present invention is preferably configured such that, in the aspect 6, the first joint (PIP joint 12) is a proximal interphalangeal joint of a robot hand; and the second joint (DIP joint 13) is a distal interphalangeal joint of the robot hand.

With the above configuration, it is possible to provide a robot hand with the first joint and the second joint each having quite low friction.

A link mechanism (multi-fingered hand 15) in accordance with aspect 13 of the present invention is preferably configured such that, in the aspect 9, the first joint (PIP joint 12), the first link 11, the second joint (DIP joint 13), and the second link 14 constitute a first finger 10 of a robot hand; and the third joint (PIP joint 18), the third link 17, the fourth joint (DIP joint 19), and the fourth link 20 constitute a second finger 16 of the robot hand.

With the above configuration, it is possible to provide a robot hand with the first to fourth joints each having quite low friction.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1: actuator unit
2: direct drive motor (motor)
3: first magnetic gear
4: second magnetic gear
5: planetary reducer
6: rotating shaft
7: encoder
8: output shaft
9: control circuit
10: first finger (link mechanism, robot hand)
11: first link
12: PIP joint (first joint)
13: DIP joint (second joint)
14: second link
15: multi-fingered hand (link mechanism, robot hand)
16: second finger (link mechanism, robot hand)
17: third link
18: PIP joint (third joint)
19: DIP joint (fourth joint)
20: fourth link
21: object (target object)

1. An actuator unit comprising:
a motor;
a first magnetic gear connected to a rotating shaft of the motor;
a second magnetic gear configured to be magnetically engaged with the first magnetic gear; and
a planetary reducer connected to a rotating shaft of the second magnetic gear.

2. The actuator unit as set forth in claim 1, wherein:
the motor includes an encoder configured to measure an amount of reverse rotation of the rotating shaft of the motor, the reverse rotation occurring when an external force torque acts on an output shaft of the planetary reducer.

3. The actuator unit as set forth in claim 2, further comprising:
a control circuit configured to control, in accordance with the amount of the reverse rotation measured by the encoder, the motor so as to absorb an impact torque acting on the output shaft of the planetary reducer.

4. The actuator unit as set forth in claim 3, wherein:
the control circuit is further configured to control the motor to compensate a cogging torque generated at a timing of switching of magnetic poles of the first magnetic gear and the second magnetic gear engaged with each other.

5. The actuator unit as set forth in claim 1, wherein:
the first magnetic gear and the second magnetic gear carry out orthogonal conversion of rotation of the motor.

6. A link mechanism comprising:
a first link;
a first joint connected to a first end of the first link;
a second joint connected to a second end of the first link; and
a second link having a first end connected to the second joint,
each of the first joint and the second joint including an actuator unit recited in claim 1.

7. The link mechanism as set forth in claim 6, further comprising:
a control circuit configured to control the motor to compensate a cogging torque generated at a timing of switching of magnetic poles of the first magnetic gear and the second magnetic gear of the first joint engaged with each other.

8. The link mechanism as set forth in claim 6, further comprising:
a control circuit configured to carry out (i) a damping control for the actuator unit of the first joint so that a force of a virtual damper acts on a second end of the second link and (ii) a compliance control for the actuator unit of the second joint so that a force of a virtual spring acts on the second end of the second link.

9. The link mechanism as set forth in claim 6, further comprising:
a third link;
a third joint connected to a first end of the third link;
a fourth joint connected to a second end of the third link; and
a fourth link having a first end connected to the fourth joint,
each of the third joint and the fourth joint including an actuator unit recited in claim 1.

10. The link mechanism as set forth in claim 9, further comprising:
a control circuit configured to execute, in order to grasp an object with a small shock, (i) a first phase that carries out a damping control for the first joint and carries out a compliance control for the second joint, (ii) a second phase that carries out a position control for the third joint and causes the fourth joint to get closer to the object, and (iii) a third phase that carries out a position control for the first joint and carries out a position control for the third joint so that a variation occurring in a virtual spring as a result of a compliance control for the fourth joint becomes constant, the first phase, the second phase, and the third phase being executed in this order.

11. The link mechanism as set forth in claim 9, further comprising:
a control circuit configured to carry out, in order to grasp an object with a small shock, a damping control for the first joint and a compliance control for the second joint as well as an angle control for the third joint and a compliance control for the fourth joint and then to control the first to fourth joints by a model constructed by a virtual spring and a virtual damper connected in parallel.

12. The link mechanism as set forth in claim 6, wherein:
the first joint is a proximal interphalangeal joint of a robot hand; and
the second joint is a distal interphalangeal joint of the robot hand.

13. The link mechanism as set forth in claim 9, wherein:
the first joint, the first link, the second joint, and the second link constitute a first finger of a robot hand; and
the third joint, the third link, the fourth joint, and the fourth link constitute a second finger of the robot hand.
